(19) United States
(12) Patent Application Publication
(10) Pub. No.: US 2023/0262715 A1
(43) Pub. Date: Aug. 17, 2023

(54) ADAPTIVE UNLICENSED SPECTRUM REVOCATION

(71) Applicant: CHARTER COMMUNICATIONS OPERATING, LLC, St. Louis, MO (US)

(72) Inventor: Volkan Sevindik, Parker, CO (US)

(73) Assignee: CHARTER COMMUNICATIONS OPERATING, LLC, St. Louis, MO (US)

(21) Appl. No.: 17/673,357

(22) Filed: Feb. 16, 2022

(51) Int. Cl. H04W 72/14; H04W 72/12; H04W 16/14

(52) U.S. Cl. CPC H04W 72/14; H04W 72/1215; H04W 16/14; H04W 88/10

(57) ABSTRACT

Various embodiments comprise systems, methods, and apparatus configured to implement citizens broadband radio service (CBRS) spectrum grant revocations by one or more Spectrum Access Systems (SASs) of some or all of spectrum already granted to the Citizens Broadband Radio Service Devices (CBSDs) in a controlled manner in accordance with one or more spectrum revocation curves (SRCs) determined by the SAS which define, for enabled CBSD, respective portions of granted spectrum to be revoked as a function of time wherein the shape of an SRC for a CBSD may selected based upon the type of CBSD traffic, the relative importance of that traffic with respect to that of other CBSDs, and other factors.

### FIELD OF THE DISCLOSURE

The present disclosure generally relates to wireless communications systems and related networks, and more particularly to dynamically constraining wireless device or network node unlicensed spectrum use prior to a loss of spectrum grant.

### BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Wireless operators, such as operators of mobile systems using Universal Mobile Telecommunications Systems (UMTSs), Long Term Evolution (LTE), and 5th Generation New Radio (5G-NR) described and being developed by the Third Generation Partnership Project (3GPP), are increasingly relying on wireless macrocell radio access networks (RANs) such as traditional cellular base stations, eNodeBs and the like, along with wireless small cell or microcell RANs in order to support numerous voice and data services. Increasing demands for wireless throughput make access to additional wireless spectrum desirable, including both licensed and unlicensed spectrum, spectrum in multiple spectral regions, such as high bands (24 GHz-40 GHz for 5G), mid bands (3.5 GHz-6 GHz and/or 1 GHz-2.6 GHz for 4G/LTE/5G), and low bands (<1 GHz for 4G/LTE/5G), and other shared spectrum.

Shared spectrum usage rules typically contemplate 3-tiered shared access; namely, (1) Incumbent operations, (2) Priority Access Licenses (PAL) which are used for commercial operation, and (3) General Authorized Access (GAA) which is available without licenses and subject to FCC Part 96 rules. GAA compliance may at times require a revocation of granted spectrum and/or a reduction in transmit power/range of devices using unlicensed spectrum (e.g., mobile network base stations/eNBs/gNBs and the like), such as when a GAA-define prioritized user requires this spectrum

Spectrum associated with citizens broadband radio service (CBRS) is currently configured as a 150 MHz band between 3.55 GHz and 3.70 GHz. Spectrum access is granted to Citizens Broadband Radio Service Devices (CBSDs, such as base stations, eNBs, gNBs, user devices and the like via a Spectrum Access System (SAS) operating in accordance with, illustratively, a CBSD-SAS registration and spectrum grant process such as that described in the WINNF-TS-0016 standards document.

Spectrum grant revocations impact network operations in a manner tending to cause non-seamless delivery of network services to user equipment (UE) since, when an amount of granted spectrum changes, a CBSD typically needs to reboot itself to ask for spectrum re-grant (e.g., a CBSD currently granted 40 MHz of spectrum having 20 MHz of that spectrum revoked by the SAS). The CBSD reboot triggers an initialization procedure after reboot that includes the CBSD interacting with the SAS to request/receive a spectrum grant (e.g., the 20 MHz that is NOT revoked from the original 40 MHz in this example). Depending on the type of CBSD, the reboot process may take 15 minutes, during which time service will be disrupted.

### SUMMARY

Various deficiencies in the prior art are addressed by systems, methods, and apparatus configured to implement citizens broadband radio service (CBRS) spectrum grant revocations by one or more Spectrum Access Systems (SASs) of some or all of spectrum already granted to the Citizens Broadband Radio Service Devices (CBSDs) in a controlled manner in accordance with one or more spectrum revocation curves determined by the SAS which define, for enabled CBSD, respective portions of granted spectrum to be revoked as a function of time.

In various embodiments, an SAS may cause each CBSD to scale back its use of the relevant spectrum over an amount of time in accordance with a respective spectrum revocation curve (SRC) having one of a plurality of shapes, where the shape of the curve may be selected based upon the type of CBSD traffic, the relative importance of that traffic with respect to that of other CBSDs, and other factors.

Embodiments include a method for dynamically adapting radio node usage of encumbered spectrum, comprising: in response to a grant revocation condition associated with using encumbered spectrum granted to one or more radio nodes, transmitting spectrum revocation messages toward the one or more radio nodes; and in response to an indication of some of the one or more radio nodes being capable of dynamic grant revocation, transmitting toward the indicated radio nodes respective spectrum revocation curve (SRC) messages, each SRC message being configured to cause a respective radio node to constrain use of granted spectrum by migrating respective users from revoked encumbered spectrum to unrevoked encumbered spectrum in accordance with the SRC.

Embodiments include a spectrum Access System (SAS) administering citizens broadband radio service (CBRS) spectrum to Citizens Broadband Radio Service Devices (CBSDs), the SAS configured for dynamically adapting CBSD usage of granted CBRS spectrum, the SAS comprising compute and memory resources configured for: in response to a grant revocation condition associated with using CBRS spectrum granted to one or more CBSDs, transmitting spectrum revocation messages toward the one or more CBSDs; and in response to an indication of some of the one or more CBSDs being capable of dynamic grant revocation, transmitting toward the indicated CBSDs respective spectrum revocation curve (SRC) messages, each SRC message being configured to cause a respective CBSD to constrain use of granted spectrum by migrating respective users from revoked encumbered spectrum to unrevoked encumbered spectrum in accordance with the SRC.

Additional objects, advantages, and novel features of the invention will be set forth in part in the description which follows, and will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 depicts a block diagram of a network architecture benefiting from the various embodiments;

FIG. 2 depicts a flow diagram of a CBSD-SAS spectrum grant revocation method in accordance with the various embodiments; and

FIG. 3A-3C graphically depicts several exemplary spectrum allocation curves in accordance with the various embodiments.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION

The following description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features, but not to others. Those skilled in the art and informed by the teachings herein will realize that the invention is also applicable to various other technical areas or embodiments.

Various embodiments will be described within the context of spectrum associated with citizens broadband radio service (CBRS), which spectrum is granted to Citizens Broadband Radio Service Devices (CBSDs) such as base stations, eNBs, gNBs, user devices and the like via Spectrum Access Systems (SASs) operating in accordance with, illustratively, a CBSD-SAS registration and spectrum grant process such as that described in the WINNF-TS-0016 standards document. It will be appreciated that the embodiments described herein with respect to the CBRS use and management by CBSDs and SASs are also applicable to other unlicensed spectral regions using automatic frequency coordination (AFC) methodologies and devices.

Various embodiments provide for spectrum grant revocations by one or more SASs of some or all of spectrum already granted to the CBSDs is realized in a controlled manner in accordance with one or more spectrum revocation curves determined by the SAS which define, for enabled CBSD, respective portions of granted spectrum to be revoked as a function of time. In this manner, rather than rebooting a CBSD may cease using and/or relinquish granted spectrum in a controlled manner such that QoS impact to services provided by the CBSD may be reduced. Further, rather than wasting spectrum by revoking a spectrum grant prior to an actual need for that spectrum by a higher priority user, or by treating all CBSDs the same, a SAS may cause each CBSD to scale back its use of the relevant spectrum over an amount of time in accordance with a respective spectrum revocation curve (SRC) having one of a plurality of shapes, where the shape of the curve may be selected based upon the type of CBSD traffic, the relative importance of that traffic with respect to that of other CBSDs, and other factors.

Spectrum revocation curves, which are determined by the SAS or other entity provide a CBSD with predicted path for migrating spectrum/channel usage so as to avoid using granted spectrum as spectrum grants are revoked over time. A SAS spectrum revocation rate defined by the spectrum revocation curve may be determined using CBSD operating statistics (e.g., CBSD loading, location, etc.), broader network requirements/conditions such as network loading or congestion conditions, and/or other factors.

Based on CBSD-specific information, broader network information, and/or a combination of this or other information, the SAS will provide to CBSDs respective spectrum revocation messages representing spectrum revocation curves so as to cause the CBSDs to controllable reduce spectrum usage in a gradual manner depending on CBSD/network need, historical statistics, and the like. The spectrum revocation curve may serve as a spectrum envelope within which a CBSD may operate so as to seamlessly (i.e., with little or no reduction in Quality of Service (QoS) or Quality of Experience (QoE)) migrate user equipment (UE) to non revoked unlicensed spectral regions, or to licensed spectral regions.

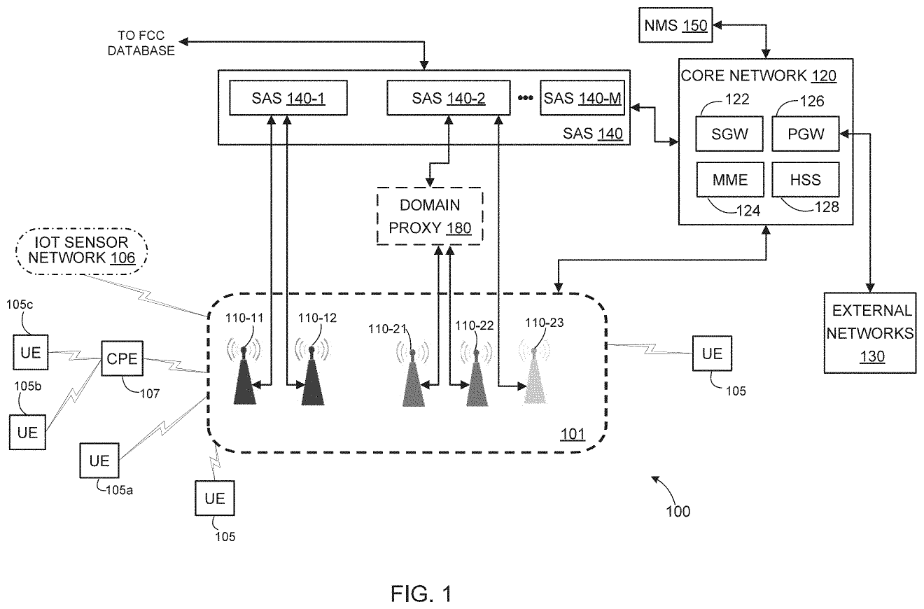

FIG. 1 depicts a block diagram of a network architecture benefiting from the various embodiments. Specifically, the network architecture 100 of FIG. 1 as depicted includes a access network 101 including a plurality of deployed network nodes 110 communicatively coupled to a core network 120 and configured to wirelessly communicate with, and provide backhaul services to, user equipment (UE) 105, IoT networks 106, and/or other devices.

The network nodes 110 may include radio nodes or wireless devices that use (or are compatible with) mobile network protocols to communicate with UE 105 and/or IoT sensors/devices 106 via unlicensed spectrum, such as may be implemented as macrocells, small cells, microcells and the like such as eNodeBs (eNBs), cellular network base stations, 4G/LTE or 5G repeaters, and similar types of provider equipment (PE) or logical radio nodes (e.g., gNBs) derived therefrom. The network nodes 110 may include nodes that use licensed 3G/4G/LTE/5G spectrum, unlicensed spectrum such as citizens broadband radio service (CBRS) spectrum, or a combination of licensed and unlicensed spectrum. The network nodes 110 may include mid-band (e.g., 3.5 GHz) mobile network nodes, low-band (e.g., under 1 GHz) mobile network nodes, or a combination of mid-band and low-band mobile network nodes.

The network nodes 110 may include those that use (or are compatible with) Wi-Fi network protocols to communicate with UE 105 via unlicensed spectrum, such as may be implemented as wireless access points deployed at home, business or other locations and configured to wirelessly communicate with and provide network services to UE 105 such as via 802.11xx or other Wi-Fi protocols. Thus, in various embodiments the network nodes 110 may uses Wi-Fi protocols, mobile network protocols, or a combination thereof within the context of licensed spectrum, unlicensed spectrum, or a combination of licensed and unlicensed spectrum.

In the case of network nodes 110 having Citizens Broadband Radio Service Device (CBSD) capability, allocations of CBRS spectrum are provided via a Spectrum Access System (SAS) 140. The various embodiments will be discussed primarily with respect to the use of CBRS spectrum by CBSD capable network nodes 110 interacting with SAS 140, though other embodiments using other unlicensed spectrum are also contemplated.

Generally speaking, the access network 101 may comprise a multi-layered network wherein network nodes 110 of differing technologies provide overlapping coverage areas such that UE 105 and IoT devices 106 having multiple radio access capability may receive network services from different layers or portions of the network (i.e., CBSD of differing technologies). Thus, the network nodes 110 forming the access network 101 may comprise CBSD nodes or a mix of CBSD and non-CBSD nodes.

The core network 120 may comprise any type of access or core network, or network technology. As depicted in FIG. 1, the network nodes 110 of the access network 101 are depicted as being connected to a core network comprising, illustratively, an evolved packet core (EPC) 120 of a 4G/LTE network. It will be appreciated that the various embodiments are not limited to this type of network. Specifically, the various embodiments are suitable for use within the context of any type of core or access network, such as 3G/4G/LTE/5G networks and the like, wherein proprietary CBSD devices may be used/configured to provide network services thereto, such as from/to external networks 130. It will be appreciated that additional mobile networks, fixed wireless access networks, domains, groups, and/or other or additional deployments of network nodes as described herein are also contemplated in various embodiments.

Each network node 110 provides network services to proximate UE 105 and/or IoT devices 106 via respective radio bearer (channels/resources) which are managed by various Radio Resource Management functions, such as Radio Bearer Control, Radio Admission Control, Connection Mobility Control, Scheduling of UE/CPE in both uplink and downlink, assignment of bandwidth parts (BWPs) to UE/CPE and so on. The Radio Resource Management functions are configured to provide appropriate Quality of Service (QoS) levels to the UE/CPE using one or more radio bearers, such as to maximize throughput at the node 110 while maintaining “fairness” to the UE/CPE or IoT devices attached thereto, to monitor various performance metrics, to provide data to the core network or network management entities and the like.

Generally speaking, each of the CBSD and non-CBS the network nodes 110 utilizes defined defines frequency ranges (FRs), such as FR1 (˜410 MHz to 7125 MHz), FR2 (˜24.25 GHz to 52.6 GHz), and so on. These frequency ranges may include both licensed and unlicensed spectrum as discussed elsewhere herein, where unlicensed spectrum includes CBRS spectral regions used by CBSD network nodes 110. Each of the spectral regions includes a plurality of operating bands, wherein each operating band is a frequency band associated with a certain set of radio frequency (RF) requirements.

Each network node 110 may include a Scheduler to implement uplink/downlink scheduling functions so as to allocate radio bearer resources to attached UE in accordance with allocated frequency bands. Further, each network node 110 may provide management data such as channel/frequency utilization level, congestion level, number of connected UE, number and type of network services being provided and so on to various management entities associated with the network operator.

The UE 105 may comprise any type of wireless device configured for use in accordance with the various embodiments, such as user terminals (e.g., mobile phones, laptops, tablets and the like), fixed wireless access devices (e.g., set top boxes, digital video recorders, stationary computing devices and the like), Internet of Things (IoT) devices (e.g., sensors, monitoring devices, alarm system devices and the like), and/or other types of wireless devices capable of communicating with the network nodes 110. The UE 105 may include UE that use licensed 3G/4G/LTE/5G spectrum, unlicensed spectrum such as CBRS spectrum, or a combination of licensed and unlicensed spectrum. In the case of network nodes 110 having CBSD capability, allocations of CBRS spectrum are provided via SAS 140.

The UE 105 may be configured to communicate directly with the network nodes 110, or via customer premises equipment (CPE) 107 such as wireless routers and other devices capable of communicating with both UE 105 and network nodes 110. Further, the CPE may also comprise CBSD CPE (e.g., a micro cell or WAP) such that SAS spectrum allocation and related management functions discussed herein with respect to the network nodes 110 are also used with such CBSD CPE.

While any type of core or access network or network technology may be used, the illustrative EPC 120 is depicted in a simplified manner as including, e.g., a service gateway (SGW) 122, a packet gateway (PGW) 126, a mobility management entity (MME) 124, and a Home Subscriber Server (HSS) 128. Various other functional elements associated with a typical EPC have been omitted for simplification of the discussion. Generally speaking, the EPC 120 supports various data plane (DP) functions and control plane (CP) functions, such as transport internet protocol (IP) data traffic (incoming and outgoing packets) between the network nodes 110 and external networks 130 (e.g., so as to support the delivery of various services to User Equipment (UE) 105 attached to the network nodes 110.

The SGW 122 is a point of interconnection between the radio-side (e.g., via a backhaul connection to the access network 101) and the EPC 120, and serves the UE 105 by routing the various incoming and outgoing IP packets. The SGW 122 is the anchor point for intra-LTE mobility (i.e. in case of handover between eNodeBs 110) and between LTE, 5G, and other 3GPP accesses. The SGW 122 is logically connected to the PGW 126.

The PGW 126 is the point of interconnect for routing packets between the EPC 120 and external packet data networks (e.g., Internet Protocol (IP) networks) 330. The PGW also performs various functions such as IP address/IP prefix allocation, policy control and charging, and other functions.

The MME 124 and HSS 128 handle user signaling or control plane (CP) functions; they process signaling related to mobility and security for network access by UE 105. The MME 124 is responsible for the tracking and the paging of UE 105 in idle-mode. It is the termination point of the Non-Access Stratum (NAS). The HSS 128 comprises a database that contains user-related and subscriber-related information, and provides support functions in mobility management, call and session setup, user authentication, access authorization, and other functions. It is noted that the SGW 122 may also be used to handle some control plane signaling in various configurations.

As depicted in FIG. 1, each of a plurality of Spectrum Access System (SASs) elements from respective SAS service providers 140-1 through 140-M (collectively SAS 140) communicates with one or more deployed CBSD network nodes 110 associated with that service provider, either directly or via a domain proxy. Each service provider's SAS 140 is configured to control access to the CBRS frequency band for RANs and other CBSD devices such as network nodes 110, UE 105, IoT networks 106, and other devices associated with that service provider. Generally speaking, each SAS 140 is configured to ensure that the CBRS frequency band is allocated for CBSD use, and that such use is adapted in accordance with government requirements, network congestion, network interference and the like.

As depicted, first service provider network nodes 110-11 and 110-12 communicate directly with first service provider SAS 140-1, second service provider network nodes 110-21 through 110-23 communicate with second service provider SAS 140-2 via a domain proxy 180 (110-21 and 110-22) or directly (110-23).

Thus, as depicted in FIG. 1, each CBSD network node 110 connects to a respective SAS directly or via a domain proxy based on CBSD design that varies among CBSD suppliers. Each CBSD network node 110 connects to one SAS at a time (one to one relationship). SAS-SAS communication may be provided to coordinate spectrum allocation. A single SAS 140 may be configured to service CBSD network nodes 110 associated with multiple service providers. An inter-SAS protocol may be used for message exchange between SASs 140, and as part of a daily Coordinated Periodic Activity Among SASs (CPAS) process.

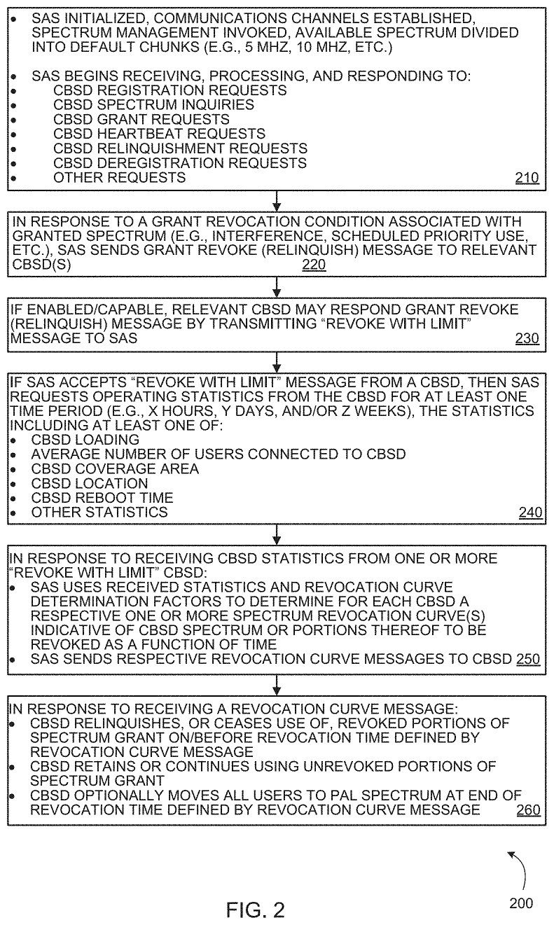

The various embodiments provide mechanisms supporting a “revoke with limit” function of CBSD and SAS, wherein “revoke with limit” enabled CBSD/SAS may be configured to operate in accordance with an updated version of a CBSD-SAS spectrum grant revocation process, such as that described in the WINNF-TS-0016 standards document. A CBSD-SAS spectrum grant revocation method in accordance with the various embodiments will be described in more detail below with respect to FIG. 2.

Various elements or portions thereof depicted in FIG. 1 and having functions described herein are implemented at least in part as computing devices having communications capabilities, including for example the UE 105, network nodes 110, SAS 140, domain proxy 180, and various portions of the EPC 120. These elements or portions thereof are implemented or instantiated via computing devices of various types, though generally a processor element (e.g., a central processing unit (CPU) or other suitable processor(s)), a memory (e.g., random access memory (RAM), read only memory (ROM), and the like), various communications interfaces (e.g., more interfaces enabling communications via different networks/RATs), input/output interfaces (e.g., GUI delivery mechanism, user input reception mechanism, web portal interacting with remote workstations and so on) and the like.

For example, various embodiments are implemented using network equipment used to support network operation/management functions at a network core or elsewhere in a provider network, the network equipment comprising processing resources (e.g., one or more servers, processors, and/or virtualized processing elements or compute resources) and non-transitory memory resources (e.g., one or more servers, storage devices, memories and/or virtualized memory or storage resources), wherein the processing resources are configured to execute software instructions stored in the non-transitory memory resources to provide thereby various functions, features, methods, management entities, and other embodiments or portions thereof as described herein.

The network equipment may also be used to provide some or all of the various other core network nodes or functions described herein.

As such, the various functions depicted and described herein may be implemented at the elements or portions thereof as hardware or a combination of software and hardware, such as by using a general purpose computer, one or more application specific integrated circuits (ASIC), or any other hardware equivalents or combinations thereof. In various embodiments, computer instructions associated with a function of an element or portion thereof are loaded into a respective memory and executed by a respective processor to implement the respective functions as discussed herein. Thus various functions, elements and/or modules described herein, or portions thereof, may be implemented as a computer program product wherein computer instructions, when processed by a computing device, adapt the operation of the computing device such that the methods or techniques described herein are invoked or otherwise provided. Instructions for invoking the inventive methods may be stored in tangible and non-transitory computer readable medium such as fixed or removable media or memory, or stored within a memory within a computing device operating according to the instructions.

FIG. 2 depicts a flow diagram of a CBSD-SAS spectrum grant revocation method in accordance with the various embodiments. Specifically, the method 200 of FIG. 2 depicts various operational adaptations of CBSD and SAS operation in response to a “revoke with limit” capability as described herein with respect to the various figures.

At step 210, an SAS is initialized, SAS-CBSD and other communications channels are established, spectrum management functions are invoked, available spectrum is divided into standard sized chunks of spectrum (e.g., 5 MHz, 10 MHz, etc.), and the SAS is made available to begin receiving, processing, and responding to CBSD requests/messages, such as: CBSD registration requests, CBSD spectrum inquiries, CBSD grant requests, CBSD heartbeat requests, CBSD relinquishment requests, CBSD deregistration requests, and/or Other requests/messages.

At step 220, in response to a grant revocation condition associated with granted spectrum (e.g., interference detected on one or more granted channels/spectral regions, scheduled priority use, etc.), an SAS sends grant revoke (relinquish) messages to the relevant CBSD(s) currently using the spectrum associated with the grant revocation condition.

At step 230, if enabled/capable, one or more of the relevant CBSDs may respond to a received grant revoke (relinquish) message by transmitting back to the SAS a “revoke with limit” message.

At step 240, in response to receiving a “revoke with limit” message from one or more CBSDs, the SAS may choose to accept some or all of the messages and configure itself and the “accepted” CBSD(s) for “revoke with limit” operation. In this cast, the SAS may request operating statistics/information from each of the accepted CBSDs for at least one common or respective time period (e.g., x hours, y days, and/or z weeks), wherein the statistics may include one or more of the of: CBSD loading, average number of users connected to the CBSD, CBSD coverage area, CBSD location, CBSD reboot time, and/or other current operating statistics or historical statistics.

At step 250, after receiving the requested operating statistics/information transmitted by one or more of the accepted CBSD(s), the SAS uses the received operating statistics/information, broader network requirements/conditions such as network loading or congestion conditions, and/or other factors to determine, for each of the accepted CBSDs, one or more respective spectrum revocation curves indicative of CBSD spectrum or portions thereof to be revoked as a function of time.

Optionally, the SAS may offload some or all of the spectrum revocation curve calculations other network management entities, such as to avoid the associated resources utilization burden (e.g., computing processing or memory resources) or to provide the network manager with a mechanism to more finely control operations within the network.

The determined spectrum revocation curve(s) associated with a CBSD provide for that CBSD path or operating envelope by which the CBSD modifies its use of granted spectrum over time to achieve, within a defined time period, CBSD spectrum use consistent with a partial or whole revocation of its granted spectrum, but (preferably) without the need for CBSD reboot or significant impact to user-delivered QoS. In essence, the path or operating envelope provides a predicted and predictable operating envelope within which the CBSD may migrate user devices away from granted spectrum being revoked and towards granted spectrum to be retained (or licensed spectrum). In situations where reboot of a CBSD is inevitable, the SAS may use the “reboot time” information from the CBSDs to determine which CBSD(s) reboot most rapidly such that total system QoS impact is lessened.

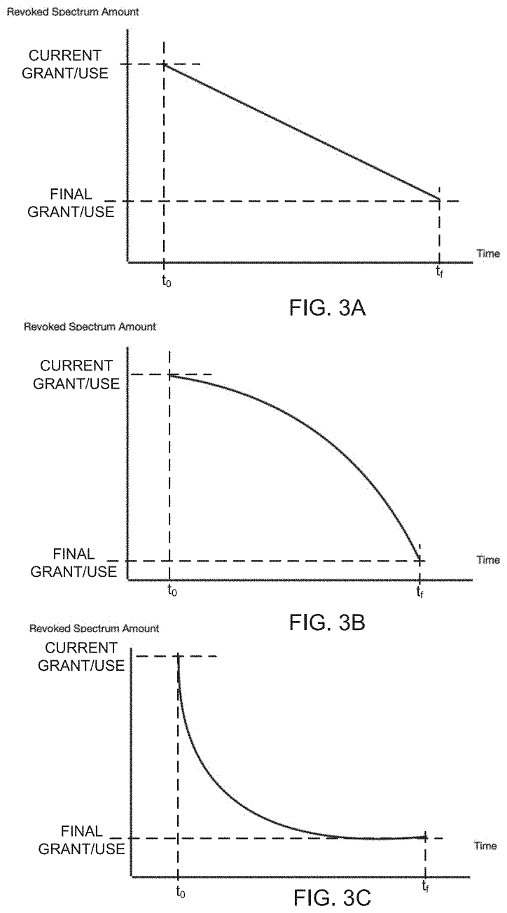

A spectrum revocation curve may be visualized as a curve comprising spectrum usage as a function of time, such as discussed below with respect to FIG. 3. All that is required is that the spectrum revocation curve define a path for a CBSD by which CBSD operation may be adapted from that associated with currently granted spectrum (or portion thereof) to that associated with final granted spectrum (or portion thereof), if any, at a final time period.

FIG. 3 graphically depicts several exemplary spectrum allocation curves in accordance with the various embodiments. Each of the depicted spectrum allocation curves contemplate a an amount of spectrum able to be used by a CBSD as a function of time, wherein the spectrum allocation progresses from a current grant or amount of spectrum used at a current time, to a final grant or amount of spectrum used at a final time. A single spectrum revocation curve may be used to define an entirety of a spectrum grant (e.g., a 5 MHz, 10 MHz, 20 MHz chunk), or a portion of a spectrum grant (e.g., a 2 MHz portion of a grant). That is, multiple spectrum allocation curves may be used to define time-banded envelopes of multiple portions of spectrum granted to a CBSD. These multiple spectrum allocation curves for a particular CBSD may have the same shape or different shapes.

Different spectrum curve shapes may be used for different purposes, such as for CBSD having different user equipment mixes or service requirements. The SAS will optionally match each CBSD with one or more of the “best” curve shapes in order avoid disrupting CBSD services. If the CBSD is not busy or has not been serving a high number of user terminals, then a linear curve (FIG. 3A) may be selected. If the CBSD is busy or has been serving a high number of user terminals, then a first non-linear curve (FIG. 3B) may be selected, wherein the rate of spectrum grant revocation over time begins slowly and then accelerates. If there is a need to rapidly vacate the relevant granted spectrum or portions thereof, then a second non-linear curve (FIG. 3C) may be selected, wherein the rate of spectrum grant revocation over time begins rapidly and then decelerates. Other curve shapes may be employed.

The SAS at step 250 further sends to the CBSD respective revocation curve messages, where each message is configured to convey to the CBSD the parameters associated with a determined spectrum revocation curves.

A “revocation curve message” associated with a spectrum revocation curve may define an affected spectrum grant or portion thereof, a final usage level or grant level associated with the affected spectrum grant, and a time by which the CBSD must reduce its usage of the affected spectrum grant or portion thereof to the final usage level or grant level.

Optionally, curve-related information may be included within the “revocation curve message” to define an envelope within which the CBSD must reduce its usage of the affected spectrum grant or portion thereof.

The curve-related information may simply comprise a plurality of spectrum grant/use levels at specific times. The curve-related information may comprise an identification of a curve shape to be used, such as a curve function by which the CBSD may calculate a plurality of spectrum grant/use levels at specific times consistent with a curve shape defined by the SAS or other management entity. Any means of describing this information to the CBSD may be used.

At step 260, in response to receiving a revocation curve message, the CBSD relinquishes, or at least ceases using, the revoked portion(s) of spectrum grant on/before the associated revocation times defined by (or discernable from) the received revocation curve message. The CBSD retains or continues using unrevoked portions of its spectrum grant. For example, the CBSD may move all users to PAL spectrum at end of a revocation time defined by a revocation curve message.

Generally speaking, and as depicted in FIG. 3, the CBSD will receive the revocation curve message at a time to and, depending on the curve, the CBSD will relinquish the identified granted spectrum portions over time, only sending data within the remaining or still granted identified granted spectrum portions up until a time t_{f}. At the, and will move all users to PAL spectrum at the end of ‘revocation time depending on the curve’.

The various SAS 140 may be configured to manage/maintain spectrum availability by terminating spectrum grants with CBSD, sharing information with other SAS pertaining to available spectrum (e.g., such as where overlapping footprints of proximate CBSDs from different service providers exist), and so on.

Further, the various SAS 140 may be configured to adapt spectrum grant usage of CBSDs in a manner that assists the network operator in avoiding congestion, avoiding QoS or QoE degradation, avoiding CBSD reboots to the extent possible, maximizing the use of unlicensed spectrum, and honoring limitations to that use such as due to the appearance or scheduled use by priority users.

Various modifications may be made to the systems, methods, apparatus, mechanisms, techniques and portions thereof described herein with respect to the various figures, such modifications being contemplated as being within the scope of the invention. For example, while a specific order of steps or arrangement of functional elements is presented in the various embodiments described herein, various other orders/arrangements of steps or functional elements may be utilized within the context of the various embodiments. Further, while modifications to embodiments may be discussed individually, various embodiments may use multiple modifications contemporaneously or in sequence, compound modifications and the like. It will be appreciated that the term “or” as used herein refers to a non-exclusive “or,” unless otherwise indicated (e.g., use of “or else” or “or in the alternative”).

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof.

What is claimed is:

1. A method for dynamically adapting radio node usage of encumbered spectrum, comprising:
in response to a grant revocation condition associated with using encumbered spectrum granted to one or more radio nodes, transmitting spectrum revocation messages toward the one or more radio nodes; and
in response to an indication of some of the one or more radio nodes being capable of dynamic grant revocation, transmitting toward the indicated radio nodes respective spectrum revocation curve (SRC) messages, each SRC message being configured to cause a respective radio node to constrain use of granted spectrum by migrating respective users from revoked encumbered spectrum to unrevoked encumbered spectrum in accordance with the SRC.

2. The method of claim 1, wherein dynamic grant revocation capability of a radio node is indicated by a revoke with limit (RWL) message received from the radio node.

3. The method of claim 1, wherein the grant revocation condition associated with using encumbered spectrum comprises a determination of interference within the granted spectrum exceeds a threshold level of interference.

4. The method of claim 1, wherein a SRC for a respective radio node is determined in accordance with operating statistics of the respective radio node.

5. The method of claim 4, wherein operating statistics of the respective radio node comprise location and current utilization level of the respective radio node.

6. The method of claim 5, wherein operating statistics of the respective radio node further comprise a restart time of the respective radio node.

7. The method of claim 4, wherein operating statistics of the respective radio node further comprise a number of users connected to the respective radio node.

8. The method of claim 1, further comprising:
transmitting a request for operating statistics toward each radio node having dynamic grant revocation capability; and
defining, for each radio node having known operating statistics, a respective SRC.

9. The method of claim 1, wherein the encumbered spectrum comprises citizens broadband radio service (CBRS) spectrum, and at least some of the at least one radio nodes comprise Citizens Broadband Radio Service Devices (CBSDs).

10. The method of claim 4, wherein:
each spectrum revocation message transmitted toward a respective CBSD is configured to cause the respective CBSD to migrate respective users from revoked encumbered spectrum to unrevoked encumbered spectrum; and
each SRC message transmitted toward a respective CBSD device is configured to define a user migration rate for the respective CBSD device.

11. The method of claim 10, wherein for a CBSD device having a utilization level above a threshold utilization level, the SRC defines a non-linear rate of user migration as a function of time.

12. The method of claim 10, wherein for a CBSD device having a number of users above a threshold number of users, the SRC defines a non-linear rate of user migration as a function of time.

13. The method of claim 1, wherein the radio node is configured to update its use of granted spectrum without rebooting.

14. The method of claim 1, wherein each SRC message is configured to cause a receiving radio node to reduce usage of granted spectrum from a current usage level to a final usage level within a defined time period.

15. The method of claim 1, wherein each SRC message is configured to cause a receiving radio node to reduce usage of a respective portion of granted spectrum from a current usage level to a final usage level within a defined time period.

16. The method of claim 1, wherein usage of a respective portion of granted spectrum is reduced in accordance with a respective curve shape.

17. The method of claim 1, wherein the radio node comprises one of a base station, eNB, and gNB in a mobile network.

18. The method of claim 1, wherein the radio node comprises a wireless access point.

19. A spectrum Access System (SAS) administering citizens broadband radio service (CBRS) spectrum to Citizens Broadband Radio Service Devices (CBSDs), the SAS configured for dynamically adapting CBSD usage of granted CBRS spectrum, the SAS comprising compute and memory resources configured for:
in response to a grant revocation condition associated with using CBRS spectrum granted to one or more CBSDs, transmitting spectrum revocation messages toward the one or more CBSDs; and
in response to an indication of some of the one or more CBSDs being capable of dynamic grant revocation, transmitting toward the indicated CBSDs respective spectrum revocation curve (SRC) messages, each SRC message being configured to cause a respective CBSD to constrain use of granted spectrum by migrating respective users from revoked encumbered spectrum to unrevoked encumbered spectrum in accordance with the SRC.

20. A computer implemented management system (MS) for dynamically adapting radio node usage of encumbered spectrum, the MS comprising compute and memory resources configured for:
in response to a grant revocation condition associated with using encumbered spectrum granted to one or more radio nodes, transmitting spectrum revocation messages toward the one or more radio nodes; and
in response to an indication of some of the one or more radio nodes being capable of dynamic grant revocation, transmitting toward the indicated radio nodes respective spectrum revocation curve (SRC) messages, each SRC message being configured to cause a respective radio node to constrain use of granted spectrum by migrating respective users from revoked encumbered spectrum to unrevoked encumbered spectrum in accordance with the SRC.
